(19) United States
(12) Patent Application Publication
(10) Pub. No.: US 2020/0098490 A1
(43) Pub. Date: Mar. 26, 2020

(54) TWIN AXIAL CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: PATRICK R. CASHER, North Aurora, IL (US); AN-JEN YANG, Irvine, CA (US)

(21) Appl. No.: 16/578,268

(22) Filed: Sep. 20, 2019

Related U.S. Application Data
(60) Provisional application No. 62/735,011, filed on Sep. 21, 2018.

(51) Int. Cl. H01B 7/02; H01B 7/08; H01B 11/00; H01B 11/10

(52) U.S. Cl. CPC H01B 7/0241; H01B 11/1091; H01B 11/002; H01B 7/0807

(57) ABSTRACT

A twin axial or differential pair cable includes a pair of wires each with an core conductor enclosed in a primary insulator, an insulative inner tape as a secondary insulation spirally wrapping both the pair of wires, a shielding tape longitudinally wrapping the inner tape with an insulative inner layer and a conductive outer layer thereof, a drain wire positioned outside of the shielding tape and at the centerline between the pair of wires, and an insulative outer tape spirally wrapping both the shielding tape and the drain wire. One feature of the invention is to have a seam of the longitudinally wrapping shielding tape located opposite to the drain wire along the centerline in a vertical direction which is perpendicular to the transverse direction defined by two centers of the wires.

### BACKGROUND OF THE DISCLOSURE

### 1. Field of the Disclosure

The present disclosure relates to a cable, in particular to a twin axial cable for use with data transmission faster than 10 Gbps.

### 2. Description of Related Arts

Traditional twin axial cables for 10 Gbps+ data transmission typically have approximately 5% coupling. Dual extrusion is an existing method that enables increasing the coupling percentage of twin axial cables. However, this method cannot rely on off-the-shelf in-line electronic process controls developed for single insulated conductors. U.S. Pat. Nos. 5,142,100, 8,981,216 and 9,123,452 disclose some related designs.

An improved twin axial cable is desired.

### SUMMARY OF THE DISCLOSURE

Accordingly, an object of the present disclosure is to provide a twin axial cable with 7%-14% signal pair coupling and the corresponding reduced signal power loss. Another object of the invention is to provide the aforementioned cable with the traditional manufacturing method rather than the dual extrusion method.

To achieve the above object, a twin axial or parallel pair cable includes a pair of wires each with a core conductor enclosed in a primary insulator, a secondary insulative inner tape spirally wrapping the pair of insulated wires, a shielding tape longitudinally wrapping the inner tape with an insulative inner layer and a conductive outer layer thereof, a drain wire positioned outside of the shielding tape and at the centerline between the pair of wires, and an insulative outer taper spirally wrapping both the shielding tape and the drain wire. One feature of the invention is to have a seam of the longitudinally wrapping shielding tape located opposite to the drain wire along the centerline in a vertical direction which is perpendicular to the transverse direction defined by two centers of the wires.

In other embodiments, the secondary layer of insulation may be longitudinally wrapping the pair or it may be made up of two tapes that are spirally wound in opposite directions.

Other objects, advantages and novel features of the disclosure will become more apparent from the following detailed description when taken in conjunction with the accompanying drawings.

### BRIEF DESCRIPTION OF THE DRAWINGS

FIG. 1 is a cross-sectional view of the twin axial cable of the first embodiment of the invention.

FIG. 2 shows the second embodiment wherein the secondary insulation is made up of two layers of insulative tape that are oppositely wound.

FIG. 3 shows a third embodiment wherein two drain wires are used; and

FIG. 4 shows a fourth embodiment wherein an additional insulation provided between the primary insulator and the insulative inner tape.

### DETAILED DESCRIPTION OF THE PREFERRED EMBODIMENT

Reference will now be made in detail to the embodiments of the present disclosure.

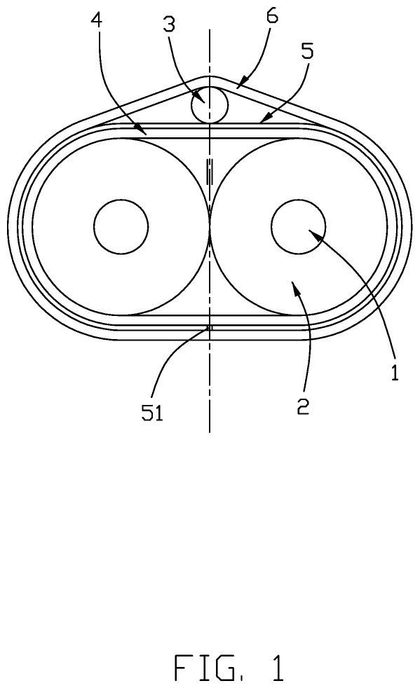

Referring to FIG. 1, a twin axial or differential pair cable includes a pair of wires, which are not twisted with each other, each with a core conductor 1 enclosed in a primary insulator 2, an insulative inner tape 4 spirally wrapping the pair of wires, a shielding tape 5 longitudinally wrapping the inner tape with an insulative inner layer and a conductive outer layer thereof, a drain wire 3 positioned on one side and outside of the shielding tape 5 and located at the centerline which is defined essentially between the pair of wires, and an insulative outer tape 6 spirally wrapping both the shielding tape 5 and the drain wire 3. One feature of the invention is to have a seam 51 of the longitudinally wrapping shielding tape 5 located around a position which is on the other side of the shielding tape 5 opposite to the drain wire 3 along the centerline in a vertical direction perpendicular to the transverse direction defined by two centers of the wires. Notably, the space formed between the inner tape 4 and the primary insulators 2 is empty, and the space formed among the shielding tape 5, the drawing wire 3 and the outer tape 6 is also empty.

The materials and dimensions of the related elements may be referred to the following tables performing 7.5%-14% coupling.

TABLE 1
for 100 ohm 7.5%

| element number | Element Construction/Material |
|---|---|
| 1 | 28 awg [321.1 μm] wire, bare, un-plated, Silver plating option |
| 2 | 1000 μm OD solid polyethylene conductor insulation, Dₖ = 2.25, D_{f} = 0.0001 |
| 3 | 32 awg [201.9 μm] drain, bare, un-plated |
| 4 | 50 μm [2 mil] polyethylene tape, spirally wrapped (detail not shown) |
| 5 | 25 um (7 μm/18 μm) Al/PET tape, Cu/PET tape option, conductive side facing |
| | out, longitudinally wrapped (detail not shown) |
| 6 | 50 μm [2 mil] clear polyester outer tape, adhesive, heat activated, spirally |
| | wrapped (detail not shown) |

Electrical performance:

| | |
|---|---|
| Differential Impedance | 101.46 ± 3 ohms |
| Common Impedance | 29.45 ± 1 ohms |
| Percent Coupling | 7.5%, 50.73 ohms Z_{odd} 58.9 ohms Zₑᵥₑₙ |

Insertion Loss

| | |
|---|---|
| Option A: Bare Cu Wire, Al/PET Shield | 4.23 dB/m @ 12.89 GHz (25 Gbps NRZ) |
| | 4.31 dB/m @13.26 (50 Gbps PAM4) |
| | 7.19 dB/m @ 26.52 GHz (100 Gbps PAM4) |
| Option B: Ag Plated Wire | 4.14 dB/m @ 12.89 GHz (25 Gbps NRZ) |
| | 4.22 dB/m @13.26 (50 Gbps PAM4) |
| | 7.03 dB/m @ 26.52 GHz (100 Gbps PAM4) |
| Option C: Ag Plated Wire, Cu/PET Shield | 4.09 dB/m @ 12.89 GHz (25 Gbps NRZ) |
| | 4.18 dB/m @13.26 (50 Gbps PAM4) |
| | 6.98 dB/m @ 26.52 GHz (100 Gbps PAM4) |

TABLE 2
for 100 ohm 8.5%

| element number | Element Construction/Material |
|---|---|
| 1 | 28 awg [321.1 μm] wire, bare, un-plated, Silver plating option |
| 2 | 965 μm OD solid polyethylene conductor insulation, Dₖ = 2.25, D_{f} = 0.0001 |
| 3 | 32 awg [201.9 μm] drain, bare, un-plated |
| 4 | 75 μm [3 mil] polyethylene tape, spirally wrapped (detail not shown) |
| 5 | 25 um (7 μm/18 μm) Al/PET tape, Cu/PET tape option, conductive side facing |
| | out, longitudinally wrapped (detail not shown) |
| 6 | 50 μm [2 mil] clear polyester outer tape, adhesive, heat activated, spirally |
| | wrapped (detail not shown) |

Electrical performance:

| | |
|---|---|
| Differential Impedance | 101.44 ± 3 ohms |
| Common Impedance | 29.97 ± 1 ohms |
| Percent Coupling | 8.3%, 50.72 ohms Z_{odd} 59.9 ohms Zₑᵥₑₙ |

Insertion Loss

| | |
|---|---|
| Option A: Bare Cu Wire, Al/PET Shield | 4.19 dB/m @ 12.89 GHz (25 Gbps NRZ) |
| | 4.27 dB/m @13.26 (50 Gbps PAM4) |
| | 7.12 dB/m @ 26.52 GHz (100 Gbps PAM4) |
| Option B: Ag Plated Wire | 4.14 dB/m @ 12.89 GHz (25 Gbps NRZ) |
| | 4.22 dB/m @13.26 (50 Gbps PAM4) |
| | 7.05 dB/m @ 26.52 GHz (100 Gbps PAM4 |
| Option C: Ag Plated Wire, Cu/PET Shield | 4.05 dB/m @ 12.89 GHz (25 Gbps NRZ) |
| | 4.14 dB/m @13.26 (50 Gbps PAM4) |
| | 6.92 dB/m @ 26.52 GHz (100 Gbps PAM4) |

TABLE 3
for 100 ohm 11.5%

| element number | Element Construction/Material |
|---|---|
| 1 | 28 awg [321.1 μm] wire, bare, un-plated, Silver plating option |
| 2 | 870 μm OD solid polyethylene conductor insulation, Dₖ = 2.25, D_{f} = 0.0001 |
| 3 | 32 awg [201.9 μm] drain, bare, un-plated |
| 4 | 150 μm [6 mil] polyethylene tape, spirally wrapped (detail not shown) |
| 5 | 25 um (7 μm/18 μm) Al/PET tape, Cu/PET tape option, conductive side facing |
| | out, longitudinally wrapped (detail not shown) |
| 6 | 50 μm [2 mil] clear polyester outer tape, adhesive, heat activated, spirally |
| | wrapped (detail not shown) |

Electrical performance:

| | |
|---|---|
| Differential Impedance | 101.28 ± 3 ohms |
| Common Impedance | 31.85 ± 1 ohms |
| Percent Coupling | 11.4%, 50.64 ohms Z_{odd} 63.71 ohms Zₑᵥₑₙ |

Insertion Loss

| | |
|---|---|
| Option A: Bare Cu Wire, Al/PET Shield | 4.04 dB/m @ 12.89 GHz (25 Gbps NRZ) |
| | 4.12 dB/m @13.26 (50 Gbps PAM4) |
| | 6.87 dB/m @ 26.52 GHz (100 Gbps PAM4) |
| Option B: Ag Plated Wire | 3.99 dB/m @ 12.89 GHz (25 Gbps NRZ) |
| | 4.08 dB/m @13.26 (50 Gbps PAM4) |
| | 6.79 dB/m @ 26.52 GHz (100 Gbps PAM4) |
| Option C: Ag Plated Wire, Cu/PET Shield | 3.92 dB/m @ 12.89 GHz (25 Gbps NRZ) |
| | 4.00 dB/m @13.26 (50 Gbps PAM4) |
| | 6.69 dB/m @ 26.52 GHz (100 Gbps PAM4) |

TABLE 4
for 100 ohm 14%

| element number | Element Construction/Material |
|---|---|
| 1 | 28 awg [321.1 μm] wire, bare, un-plated, Silver plating option |
| 2 | 825 μm OD solid polyethylene conductor insulation, Dₖ = 2.25, D_{f} = 0.0001 |
| 3 | 32 awg [201.9 μm] drain, bare, un-plated |
| 4 | 200 μm [8 mil] polyethylene tape, spirally wrapped (detail not shown) |
| 5 | 25 um (7 μm/18 μm) Al/PET tape, Cu/PET tape option, conductive side facing |
| | out, longitudinally wrapped (detail not shown) |
| 6 | 50 μm [2 mil] clear polyester outer tape, adhesive, heat activated, spirally |
| | wrapped (detail not shown) |

Electrical performance:

| | |
|---|---|
| Differential Impedance | 101.64 ± 3 ohms |
| Common Impedance | 33.48 ± 1 ohms |
| Percent Coupling | 13.7%, 50.82 ohms Z_{odd} 66.97 ohms Zₑᵥₑₙ |

Insertion Loss

| | |
|---|---|
| Option A: Bare Cu Wire, Al/PET Shield | 3.95 dB/m @ 12.89 GHz (25 Gbps NRZ) |
| | 4.04 dB/m @13.26 (50 Gbps PAM4) |
| | 6.72 dB/m @ 26.52 GHz (100 Gbps PAM4) |
| Option B: Ag Plated Wire | 3.91 dB/m @ 12.89 GHz (25 Gbps NRZ) |
| | 3.99 dB/m @13.26 (50 Gbps PAM4) |
| | 6.65 dB/m @ 26.52 GHz (100 Gbps PAM4) |
| Option C: Ag Plated Wire, Cu/PET Shield | 3.85 dB/m @ 12.89 GHz (25 Gbps NRZ) |
| | 3.93 dB/m @13.26 (50 Gbps PAM4) |
| | 6.56 dB/m @ 26.52GHz (100 Gbps PAM4) |

The invention has the following features and benefits. Even though not all respective features and benefits are totally new, anyhow the combinations as shown in the embodiments and defined in the claims are novel and have the specific advantages to meet the transmission faster than 10 Gbps while still using the traditional manufacturing method.

Tighter signal pair coupling, 7% to 14%, provides an improved insertion loss for differential signals
Differential shield return currents of opposite polarity are partially cancelled, reducing the shield power loss
Traditional twin-ax have approximately 5% coupling.

Having the drain wire located outside foil shield reduces its impact high frequency data transmission performance
Drain wires have memory from being wound on a spool that makes them retain the circularly wound shape after being removed from the spool. Consequently, maintaining a constant location within the twin axial cable structure over the length of the cable challenging. This creates a twin axial cable that does not have a constant symmetric cross-section over the length of the cable. This asymmetry creates an electrical imbalance.
The outside location reduces mode conversion potential due to physical/electrical imbalance. The physically balance of the symmetry within the foil shield is what affects the electrical signal balance. As long as the geometry is balanced symmetrically within the symmetry of the structure does not impact the electrical balance.
Opposed to an internal drain wire were its variable location would result in variable “tenting” of the foil shield which would affect the electrical balance of the differential pair and ultimately high speed performance

Longitudinally wrapped shield
Eliminates insertion loss “suck-out” seen in traditional spirally wrapped shield constructions

Foil shield is captured between inner dielectric tape wrap and outer tape wrap. In addition, the foil seam is located on the bottom side of the twin-ax, the side opposite the drain wire
This Provides improved control of longitudinal shield seam, captures it between two flat surfaces
Which prevents the shield seam from opening up which causes high speed electrical performance degradation
Longitudinal shield seams can open up under stresses from manufacturing, “bundling”, process and field application, bending/routing
This will help reduce mode conversion and the associated insertion loss deviation from linear performance and pair-to-pair variation it can create

Foil-out, PET tape in, provides oxidation barrier on surface conducting high-speed reference currents
Resistive to environmental degradation
Improved stability of long term performance

Solid Dielectric
More consistent performance than foam dielectric
Simpler to manufacture than a foamed dielectric

Available with optional copper, Cu/PET, shield
30% more conductive than aluminum, Al/PET

Available with option silver plated wires
6% more conductive the bare copper wires

Manufactured using traditional processes
No dual extrusion or 2^{nd} layer extrusion needed
Uses conventional in-line process controls (capacitance meters, concentricity meters, ovality meters)
Adds only a 2^{nd} taping section to twin-ax cabling process

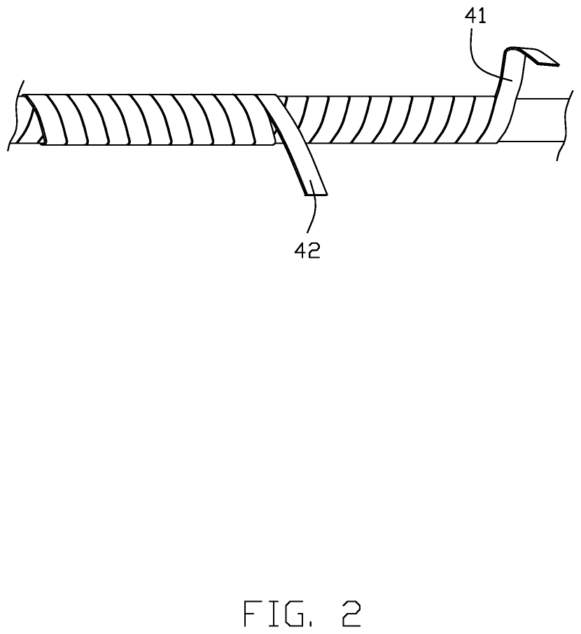

FIG. 2 shows the second embodiment in which the insulative inner tape are of double layers, i.e., an inner layer 41 and an outer layer 42, which are oppositely wound. It is noted that the structure of oppositely wound two layers is disclosed in U.S. Pat. No. 7,790,981. Anyhow, such a pseudo-intersection structure occurs on the outer tape outside of the shielding tape, thus having relatively less electrical performance improvement but essentially being of the mechanical securing consideration. Differently, in the second embodiment of the instant invention, the oppositely wrapped layers of the inner tape cooperating with the outer shielding tape may provide critical and unexpected electrical performance arrangement for the high frequency signal transmission. The detailed analyses are given as follows. To elaborate, when spirally wrapping inner tape, there will be periodic overlaps of the tape. The overlapped regions will be thicker than the non overlapped regions. One potential impact of the overlapped regions is that, with the increased secondary dielectric thickness, the distance from the signal wires to the out shield will increase. A second potential impact is that the thickness does not increase at the overlaps but that the dielectric tape is compressed more at the overlaps increasing that materials dielectric constant in this region, These periodic over laps, changes in the electrical relation between the signal conductors and the shield conductor, will create an electrically resonant structure. The frequency of the resonance directly tied to the pitch of the overlaps. Depending on the thickness differences the electrical affect will become more or less apparent. The two oppositely wrapped dielectric tapes would each be half the thickness of the single tape wrapped in one direction. Thus decreasing the thickness or compression of the overlaps. In addition, the two overlaps would be more distributed, forming an “X” like pattern versus a “\” like pattern down the cable. This would help reduce the negative electrical impact. Notably, the opposite wrapping of the outer tape disclosed in the related previous patent reference is to keep the outer tape from opening up under twisting or bending forces. When this outer tape opens up, then the longitudinal shield tape seam opens up and there is mode conversion. The related patent reference uses two way for preventing the longitudinal shield tape from opening by (1) The selectively applied adhesive to the shield to 1A) periodically glue the longitudinal shield seam together while still periodically having electrical contact pads along the seam edge and 1B) to glue the shield to the “primary” insulations; (2) The have two layers of outer tape wrapped in opposite directions. In brief, the feature of the double layer in opposite wrapping directions of the inner tape within the longitudinally wrapped shield tape of the instant invention has the significant electrical characters and the different purpose/performance impact compared with the aforementioned patent references. In the second embodiment, the wrapping direction of the outer tape may be opposite to the outer layer 42 of the insulative inner tape while same with that of the inner layer 41 of the insulative inner tape, if desired.

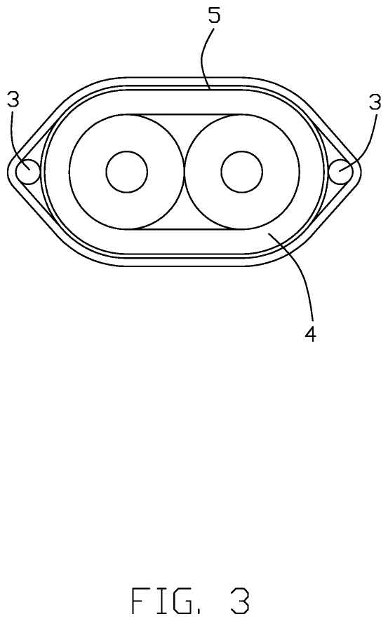

FIG. 3 shows the third embodiment wherein the insulative inner tape is relative thicker than that in the first embodiment, and two drain wires 3 are used by two sides of the cable so that the seam of the shielding tape 5 is located between the two drain wires 3 in a top view.

TABLE 5
electrical characteristics of the third embodiment

| Item | | | Description | |
|---|---|---|---|---|
| Parallel | Conductor | AWG | 28 | |
| pairs | | Material | Silver Plated Copper | |
| | | Construction | 1/0.32 | mm |
| | Insulation | Material | Solid PE | |
| | | Diameter | 0.825 mm (Nom.) | |
| | 2nd Layer | Material | PE Tape | |
| | Insulation | Thickness | PE Tape | |
| | | Taping Type | Spiral | |
| | Shielding | Material | AL/PET (Metal side Face Outside) | |
| | Tape | Thickness | 25 | μm |
| | | Taping Type | Longitudinal | |
| | Drain | AWG | 32 | |
| | Wire | Material | Silver Plated Copper | |
| | | Construction | 1/0.20 | mm |
| | Outer | Material | Heat Seal PET | |
| | Tape | Thickness | 18 | μm |

| | |
|---|---|
| Taping Type | Spiral |

| | |
|---|---|
| Diameter | 1.29 mm*2.51 mm(Nom.) |

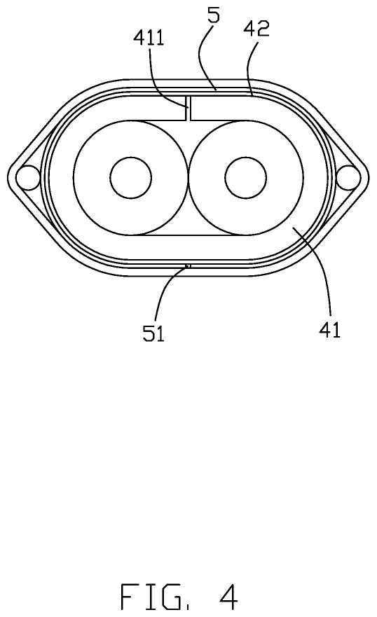

FIG. 4 shows the fourth embodiment which is similar to the third embodiment except that the inner tape is replaced with a thinner spirally wrapped (outer) heat seal layer 42 and a thicker longitudinally wrapped (inner) insulation layer 41. As shown in FIG. 4, the seam 51 of the shielding tape 5 is opposite to the seam 411 of the insulation layer 41 in the vertical direction.

TABLE 6
electrical characteristics of the fourth embodiment

| Item | | | Description | |
|---|---|---|---|---|
| Parallel | Conductor | AWG | 28 | |
| pairs | | Material | Silver Plated Copper | |
| | | Construction | 1/0.32 | mm |
| | Insulation | Material | Solid PE | |
| | | Diameter | 0.825 mm (Nom.) | |
| | 2nd Layer | Material | PE Tape | |
| | Insulation | Thickness | 170 | μm |
| | | Taping Type | Longitudinal | |
| | Inner Tape | Material | Heat Seal PET | |
| | | Thickness | 11 | μm |
| | | Taping Type | Spiral | |
| | Shielding | Material | AL/PET (Metal side Face Outside) | |
| | Tape | Thickness | 25 | μm |
| | | Taping Type | Longitudinal | |
| | Drain | AWG | 32 | |
| | Wire | Material | Silver Plated Copper | |
| | | Construction | 1/0.20 | mm |
| | Outer | Material | Heat Seal PET | |
| | Tape | Thickness | 18 | μm |

| | |
|---|---|
| Taping Type | Spiral |

| | |
|---|---|
| Diameter | 1.33 mm*2.56 mm(Nom.) |

While a preferred embodiment in accordance with the present disclosure has been shown and described, equivalent modifications and changes known to persons skilled in the art according to the spirit of the present disclosure are considered within the scope of the present disclosure as described in the appended claims. In this invention, the key feature is to control the spacing between the signal conductors relative to the spacing between the shielding tape and the signal conductors. As shown in FIG. 1, the distance between the signal wires is essentially equal to two times of a thickness of the core insulator while the distance between the shielding tape and the respective signal wires is essentially equal to a sum of the insulative inner tape and the thickness of the core insulator. According to what is shown in FIG. 4, these two distance are roughly equal to each other. In addition, the insulative inner tape could include two layers wrapped opposite directions, i.e., one being clockwise and the other being counterclockwise for achieving smaller intersecting seams with more uniformity thereof. On the other hand, the double layers of the opposite wrapping may avoid periodic structures and/or discontinuities with a dense thickness thereof.

What is claimed is:

1. A twin axial cable comprising:
a pair of wires each with a core conductor enclosed in a primary insulator, an insulative inner tape spirally wrapping the pair of wires, a shielding tape longitudinally wrapping the inner tape with an insulative layer and a conductive layer thereof, a drain wire positioned outside of the shielding tape and at a centerline between the pair of wires, and an insulative outer tape spirally wrapping both the shielding tape and the drain wire.

2. The twin axial cable as claimed in claim 1, wherein a seam of the longitudinally wrapping shielding tape is located opposite to the drain wire along a centerline in a vertical direction which is perpendicular to the transverse direction defined by two centers of the wires.

3. The twin axial cable as claimed in claim 1, wherein a space formed between the inner tape and the primary insulators is empty.

4. The twin axial cable as claimed in claim 1, wherein a space formed among the shielding tape, the drawing wire and the outer tape is empty.

5. The twin axial cable as claimed in claim 1, wherein the inner tape includes inner and outer layers wrapped in opposite directions.

6. The twin axial cable as claimed in claim 5, wherein the spirally wrapping inner tape has periodic overlaps of the tape, the overlapped regions are thicker than the non overlapped regions.

7. The twin axial cable as claimed in claim 6, wherein overlapped regions form an “X” like pattern.

8. The twin axial cable as claimed in claim 5, wherein the wrapping direction of the outer tape may be opposite to the outer layer of the inner tape while same with that of the inner layer of the inner tape.

9. The twin axial cable as claimed in claim 1, wherein the insulative layer of the shielding tape is located inside the conductive layer thereof so as to have the conductive layer is directly electrically connected to the drawing wire.

10. A twin axial cable comprising:
a pair of wires each with a core conductor enclosed in a primary insulator, an insulative inner tape spirally wrapping the pair of wires, a shielding tape longitudinally wrapping the inner tape with an insulative inner layer and a conductive outer layer thereof, a pair of drain wires positioned outside of the shielding tape and located on both sides of the center line of the pair of wires, and an insulative outer tape spirally wrapping both the shielding tape and the drain wire.

11. The twin axial cable as claimed in claim 10, wherein the seam of the shielding tape is located between the pair of drain wires.

12. The twin axial cable as claimed in claim 11, wherein the inner tape includes a thinner spirally wrapped heat seal layer and a thicker longitudinally wrapped insulation layer.

13. The twin axial cable as claimed in claim 12, wherein the thinner spirally wrapped heat seal layer is located outside of the thicker longitudinally wrapped insulation layer

14. The twin axial cable as claimed in claim 13, wherein the seam of the shielding tape is opposite to the seam of the insulation layer along said centerline in a vertical direction.

15. The twin axial cable as claimed in claim 10, wherein the inner tape includes inner and outer layers wrapped in different directions.

16. The twin axial cable as claimed in claim 15, wherein the inner layer of the insulative inner tape and the insulative outer tape are wrapped in a same direction.

17. The twin axial cable as claimed in claim 10, wherein a thickness of the primary insulator is roughly equal to a sum of a thickness of the insulative inner tape and that of the shielding tape.

18. A twin axial cable comprising:
a pair of wires each with a core conductor enclosed in a primary insulator, an insulative inner tape spirally wrapping the pair of wires, a shielding tape longitudinally wrapping the inner tape with an insulative layer and a conductive layer thereof, at least a drain wire positioned outside of the shielding tape and at a centerline between the pair of wires or by a lateral side of the pair of wires, and an insulative outer tape spirally wrapping both the shielding tape and the drain wire.

19. The twin axial cable as claimed in claim 18, wherein the insulative layer of the shielding tape is located inside of the conductive layer thereof so as to have the drain wire directly mechanically and electrically connect the conductive layer.

20. The twin axial cable as claimed in claim 19, wherein a seam of the shielding tape is opposite to said at least drain wire with said pair of wires therebetween.
